(19) United States
(12) Patent Application Publication
(10) Pub. No.: US 2026/0192774 A1
(43) Pub. Date: Jul. 9, 2026

(54) SEATBELT GUIDE AND VEHICLE SEAT

(71) Applicants: NHK SPRING CO., LTD., Yokohama-shi (JP); SUBARU CORPORATION, Tokyo (JP)

(72) Inventors: Nobuhiko NAMEGAYA, Yokohama-shi (JP); Atsushi KAGEYAMA, Yokohama-shi (JP); Ken WAKUI, Yokohama-shi (JP); Toshiaki SUNAGA, Yokohama-shi (JP); Yuki YASUOKA, Yokohama-shi (JP); Hiroki SHODA, Yokohama-shi (JP); Jun AOKI, Yokohama-shi (JP); Kenichiro MORIZONO, Yokohama-shi (JP); Takahiro ITOIGAWA, Yokohama-shi (JP); Sota MOCHIHARA, Yokohama-shi (JP); Tomoya TAKAHASHI, Yokohama-shi (JP); Yosuke ISHIYAMA, Tokyo (JP); Taiki ONO, Tokyo (JP); Masato FUKUSHIMA, Tokyo (JP); Fumito KITANAKA, Tokyo (JP); Tatsuya SAWADA, Tokyo (JP); Kouta MORISHIMA, Tokyo (JP); Yoshitaka NAKAMURA, Tokyo (JP); Yoshinori SAKUMA, Tokyo (JP); Shinya INOUE, Tokyo (JP); Takeshi ITO, Tokyo (JP); Akihiro ONODERA, Tokyo (JP); Kazuya FUJIWARA, Tokyo (JP)

(21) Appl. No.: 19/439,815

(22) Filed: Jan. 5, 2026

(30) Foreign Application Priority Data
Jan. 8, 2025 (JP) 2025-003053

(51) Int. Cl. B60R 22/26; B60R 22/18

(52) U.S. Cl. CPC B60R 22/26; B60R 2022/1818; B60R 2022/266

(57) ABSTRACT

A seatbelt guide including a base section fixed to a shoulder section of a seatback of a vehicle seat, and a belt guide section that extends from the base section toward a seat upper side and that includes a webbing insertion through-hole, through which a webbing of a three-point seatbelt device is inserted, formed so as to pass through the belt guide section in a seat front-rear direction. The webbing insertion through-hole is formed in an elongated hole shape inclined toward a seat upper side on progression toward a seat width direction outer side.

### CROSS-REFERENCE TO RELATED APPLICATION

This application is based on and claims priority under 35 USC 119 from Japanese Patent Application No. 2025-003053 filed on Jan. 8, 2025, the disclosure of which is incorporated by reference herein.

### BACKGROUND

### Technical Field

The present disclosure relates to a vehicle seat, and in particular relates to a seatbelt guide provided to a shoulder section of a seatback for guiding webbing of a three-point seatbelt device.

### Related Art

Japanese Patent Application Laid-Open (JP-A) No. 2002-2443 discloses a seatbelt guide provided to a shoulder section of a seatback of a vehicle seat. A belt insertion through-hole is formed at the seatbelt guide for insertion of a seatbelt (webbing) of a three-point seatbelt device. This belt insertion through-hole (webbing insertion through-hole) is inclined further toward the seat lower side on progression toward the seat width direction outer side.

JP-A No. 2010-23750 discloses a seatbelt guide provided to a shoulder section of a seatback of a vehicle seat. The seatbelt guide includes a base section fixed to the seatback shoulder section, and an upper guide section arranged at an upper side of the base section. The base section is inclined further toward the seat lower side on progression toward the seat width direction outer side. The upper guide section includes a long hook extending from a seat width direction outer side end portion of the base section toward a seat upper side and seat width direction inner side, with the webbing being guided between the long hook and the base section.

### SUMMARY

In each of the related art described above, during a head-on collision of a vehicle, the webbing attempts to move toward the seat width direction outer side and seat lower side with respect to the seatbelt guide under load from a passenger attempting to move under inertia toward the vehicle front side. There is accordingly a possibility that the restraining performance by the webbing of a passenger is adversely affected if the passenger has a small build.

An object of the present disclosure is to obtain a seatbelt guide capable of suppressing webbing in a webbing insertion through-hole from moving toward the seat width direction outer side and seat lower side under load from a passenger during a head-on collision of a vehicle, and to obtain a vehicle seat including such a seatbelt guide.

A seatbelt guide of a first aspect of the present disclosure includes a base section fixed to a shoulder section of a seatback of a vehicle seat, and a belt guide section that extends from the base section toward a seat upper side and that includes a webbing insertion through-hole, through which a webbing of a three-point seatbelt device is inserted, formed so as to pass through the belt guide section in a seat front-rear direction. The webbing insertion through-hole is formed in an elongated hole shape inclined toward a seat upper side on progression toward a seat width direction outer side.

In the seatbelt guide of the first aspect, the base section is fixed to the shoulder section of the seatback of the vehicle seat. The belt guide section that extends from the base section toward the seat upper side includes the webbing insertion through-hole for inserting webbing of a three-point seatbelt device through formed passing through the belt guide section in the seat front-rear direction. The webbing insertion through-hole is formed with an elongated hole shape inclined toward the seat upper side on progression toward the seat width direction outer side. This accordingly means that the webbing is not liable to move toward the seat width direction outer side and seat lower side inside the belt insertion through-hole under load from a passenger during a vehicle head-on collision.

A seatbelt guide of a second aspect is the first aspect, wherein an upper portion of the webbing insertion through-hole is configured as a run-up portion having a greater inclination angle with respect to a seat width direction than a lower portion of the webbing insertion through-hole.

In the seatbelt guide of the second aspect, the upper portion of the webbing insertion through-hole configured by an elongated hole shape inclined toward the seat upper side on progression toward the seat width direction outer side is configured as a run-up portion having a greater inclination angle with respect to the seat width direction than the lower portion of the webbing insertion through-hole. This means that the webbing runs up inside the run-up portion even in cases in which the webbing has moved toward the seat width direction outer side (namely, the seat upper side) inside the webbing insertion through-hole under load from a passenger during a vehicle head-on collision. This thereby enables the webbing to be prevented from creasing inside the seat width direction outer side end portion of the webbing insertion through-hole.

A seatbelt guide of a third aspect is the first aspect or the second aspect, wherein a slit is formed at the belt guide section so as to be in communication with a height direction intermediate portion of the webbing insertion through-hole from a seat width direction inner side.

In the seatbelt guide of the third aspect, the webbing can be inserted inside the webbing insertion through-hole from the slit formed in the belt guide section. Moreover, the slit is in communication with the height direction intermediate portion of the webbing insertion through-hole from the seat width direction inner side, and so the webbing is easily prevented from coming out from the webbing insertion through-hole unintentionally.

A seatbelt guide of a fourth aspect is the third aspect, wherein, in the belt guide section, rounded-face profiles are formed at both upper and lower edge portions of an opening on a webbing insertion through-hole side of the slit.

In the seatbelt guide of the fourth aspect, the slit formed at the belt guide section has rounded-face profiles formed at both the upper and lower edges of the opening on the webbing insertion through-hole side. This accordingly means that the width direction end portions of the webbing are not liable to enter inside the webbing slit even when the webbing has moved up or down inside the webbing insertion through-hole. As a result thereof, the webbing can be even more easily prevented from coming out from the webbing insertion through-hole unintentionally.

A seatbelt guide of the fifth aspect is the second aspect, wherein the lower portion of the webbing insertion through-hole is formed with a linear shape.

In the seatbelt guide of the fifth aspect, the lower portion of the webbing insertion through-hole is formed with a linear shape, and so the resistance can be reduced when the webbing slides in the seat front-rear direction in the lower portion inside the webbing insertion through-hole.

A seatbelt guide of a sixth aspect is the second aspect, wherein the lower portion of the webbing insertion through-hole is set with an inclination angle of not greater than 45° with respect to the seat width direction.

In the seatbelt guide of the sixth aspect, the inclination angle of the lower portion of the webbing insertion through-hole is set as described above, enabling good webbing take-up characteristics to be achieved for a retractor of a three-point seatbelt device.

A seatbelt guide of a seventh aspect is any one aspect of the first aspect to the sixth aspect, wherein the belt guide section is arranged at a position so as not to jut out to the seat width direction outer side from the shoulder section of the seatback.

In the seatbelt guide of the seventh aspect, the belt guide section is arranged at a position so as not to jut out to the seat width direction outer side from the shoulder section of the seatback, and so a configuration can be achieved in which the belt guide section does not get in the way when the seatback is tilted forward or tilted backward.

The vehicle seat of an eighth aspect includes a seat cushion for a passenger of a vehicle to sit on, a seatback to support a back of the passenger, and the seatbelt guide of any one aspect of the first aspect to the seventh aspect in which the base section is fixed to the shoulder section of the seatback.

In the vehicle seat of the eighth aspect, the back of the passenger seated on the seat cushion is supported by the seatback. The seatbelt guide having its base section fixed to the shoulder section of the seatback is any one aspect of the first aspect to the seventh aspect, and so the above described advantageous effects are also obtained.

As described above, the seatbelt guide and the vehicle seat according to the present disclosure enable webbing to be suppressed from moving toward the seat width direction outer side and seat lower side inside a webbing insertion through-hole under load from a passenger during a vehicle head-on collision.

### BRIEF DESCRIPTION OF THE DRAWINGS

Exemplary embodiments of the present invention will be described in detail based on the following figures, wherein:

FIG. 1 is a front view illustrating part of a vehicle seat according to an exemplary embodiment;

FIG. 2 is a front view illustrating a seatbelt guide according to an exemplary embodiment;

FIG. 3 is a perspective view illustrating a seatbelt guide according to an exemplary embodiment;

FIG. 4 is front view illustrating a seatbelt guide according to an exemplary embodiment, and is a diagram for explaining movement of webbing inside a webbing insertion through-hole;

FIG. 5 is a front view illustrating a seatbelt guide according to a comparative example, and is a diagram for explaining movement of webbing inside a webbing insertion through-hole in a comparative example;

FIG. 6 is a front view illustrating a seatbelt guide according to an exemplary embodiment, and is a first diagram to explain a relationship between a slit and webbing;

FIG. 7 is a front view illustrating a seatbelt guide according to an exemplary embodiment, and is a second diagram to explain a relationship between a slit and webbing; and

FIG. 8 is a front view illustrating a part of a vehicle seat according to a comparative example, and is a diagram for explaining a situation in which webbing moves toward the seat width direction outer side and seat lower side during a vehicle head-on collision.

### DETAILED DESCRIPTION

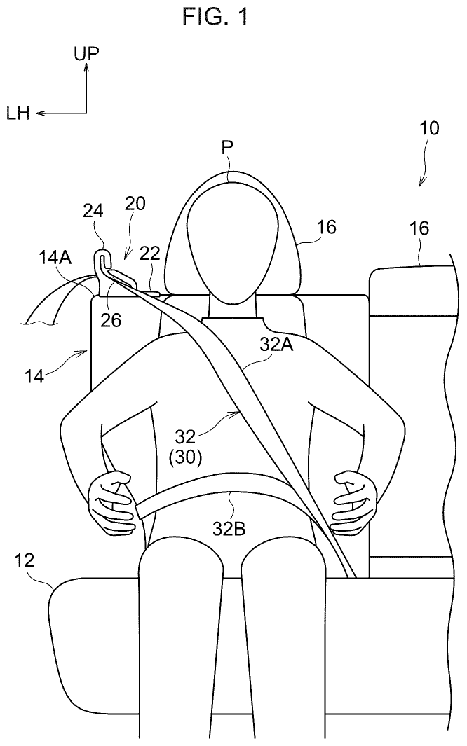

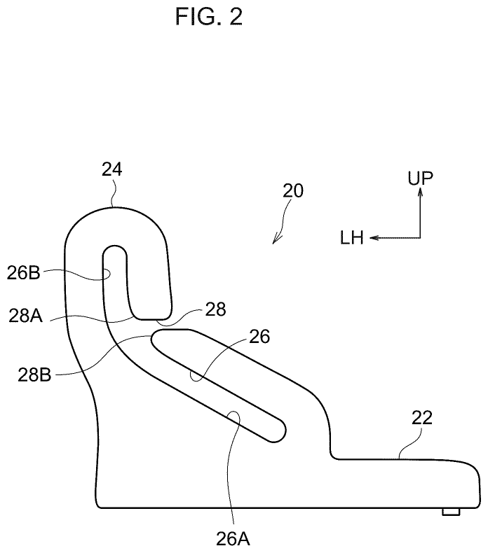

Explanation follows regarding a vehicle seat 10 according to an exemplary embodiment of the present disclosure, with reference to FIG. 1 to FIG. 8. Note that in the drawings some reference numerals are omitted to enhance drawing clarity. Moreover, as appropriate in the drawings, the arrows FR, LH, RH, and UP respectively indicate forward, rightward, leftward, and upward for the vehicle seat 10. When reference in the following description is made simply to front and rear, left and right, and up and down then this indicates these directions with respect to the vehicle seat 10.

As illustrated in FIG. 1, the vehicle seat 10 according to the present exemplary embodiment includes a seat cushion 12 for a passenger to sit on, a seatback 14 to support the back of a passenger, and a headrest 16 to support the head of the passenger. The vehicle seat 10 is, as an example, a three-person rear seat provided with headrests 16 at the left-right direction center and both left-right direction sides of an upper end section of the seatback 14 (the left headrest 16 is omitted in the drawings). The front and rear, left and right, and up and down directions of the vehicle seat 10 are aligned with the front and rear, left and right, and up and down directions of the vehicle.

Respective seatbelt guides 20 are attached to shoulders sections 14A at the left and right (seat width direction outer side; vehicle width direction outer side) of the seatback 14 (the seatbelt guide 20 of the left side is omitted in the drawings). The left and right seatbelt guides 20 have the same configuration as each other, apart from being formed with left-right symmetry to each other, and so the seatbelt guide 20 on the right side will be described below, with description of the seatbelt guide 20 on the left side omitted. Moreover, the seatbelt guide 20 on the right side is simply referred to as seatbelt guide 20 in the following description.

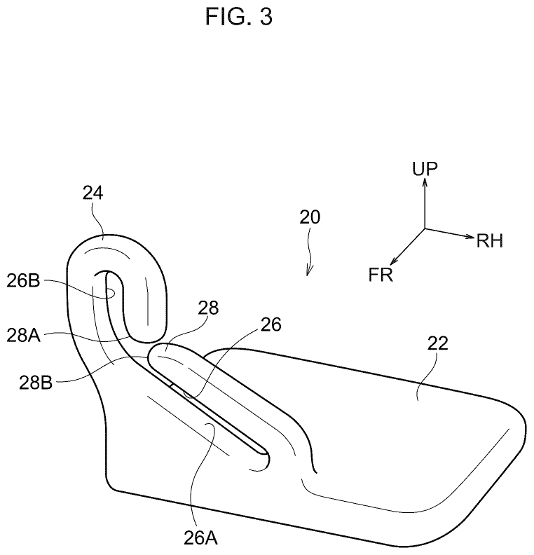

As illustrated in FIG. 1 and FIG. 3, the seatbelt guide 20 includes a base section 22 fixed to the shoulder section 14A of the seatback 14, and a belt guide section 24 extending upward from the base section 22. The seatbelt guide 20 is, for example, configured from a resin, insert-molded with a metal plate member formed by press molding as an insert. The base section 22 is formed with a substantially rectangular plate shape having a length direction along the left-right direction and a thickness direction along the height direction, and is fixed to a frame (omitted in the drawings) of the seatback 14 by means such as bolt-fastening or the like.

The belt guide section 24 extends from a front end portion of the base section 22 toward the upper side, and is arranged shifted to the right side (seat width direction outer side; vehicle width direction outer side) of a front end portion of the base section 22. The belt guide section 24 is formed in a substantially triangular shape when viewed along the front-rear direction, with a projection height to the upper side that becomes higher on progression toward the right side. An elongated hole shaped webbing insertion through-hole 26 is formed passing through the belt guide section 24 in the front-rear direction. As illustrated in FIG. 1, a webbing 32 of a three-point seatbelt device 30 is inserted through the webbing insertion through-hole 26.

A length direction one-end portion of the webbing 32 is anchored to a take-up shaft of a non-illustrated retractor provided at a non-illustrated vehicle body side section arranged at the right side of the vehicle seat 10. A length direction other-end portion of the webbing 32 is anchored to a non-illustrated anchor plate provided to a non-illustrated vehicle body floor on the right side of the vehicle seat 10. A non-illustrated tongue plate is attached to a length direction intermediate portion of the webbing 32. A location between the tongue plate and the retractor of the webbing 32 is inserted through the webbing insertion through-hole 26 formed in the belt guide section 24 of the seatbelt guide 20.

A non-illustrated buckle capable of engaging with the tongue plate is provided between the left-right direction central portion and right side portion of the seat cushion 12. A passenger P (see FIG. 1) seated on a right side section of the vehicle seat 10 grips the tongue plate and engages it with the buckle to achieve a state wearing the webbing 32. In a webbing wearing state, the locations of the webbing 32 between the seatbelt guide 20 and the tongue plate configure a shoulder belt 32A for restraining the upper body including the right shoulder of the passenger P, and locations of the webbing 32 between the tongue plate and the anchor plate configure a lap belt 32B for restraining the waist of the passenger P. Note that the passenger P illustrated in FIG. 1 is, for example, an American Female 5 percentile (AF05) dummy.

The webbing insertion through-hole 26 formed in the belt guide section 24 of the seatbelt guide 20 is formed with an elongated hole shape inclined upward on progression toward the right side (seat width direction outer side). The webbing 32 is accordingly configured so as not to be liable to be moved toward the right side (seat width direction outer side) inside the webbing insertion through-hole 26 under load from the passenger P attempting to move under inertia toward the vehicle front side during a vehicle head-on collision. The width dimension of the webbing insertion through-hole 26 is set larger than the thickness of the webbing 32 and, for example, is set to 7 mm or less. A peripheral portion and the two length direction end portions of the webbing insertion through-hole 26 are formed with rounded profiles.

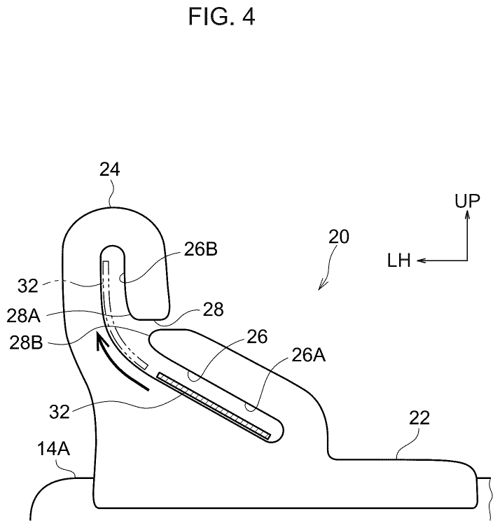

The webbing insertion through-hole 26 forms a substantially chevron-shape (substantially L-shape) bent so as to project toward the right side and lower side. A lower portion of the webbing insertion through-hole 26 is configured as a normal insertion section 26A through which the webbing 32 is inserted during normal usage (see the webbing 32 illustrated by solid lines in FIG. 4). The normal insertion section 26A is formed in a straight line shape, and is inclined upward on progression toward the right side. The normal insertion section 26A is set with an inclination angle of from 30° to 45° with respect to the left-right direction (seat width direction).

An upper portion of the webbing insertion through-hole 26 is configured as a run-up portion 26B having a greater inclination angle with respect to the left-right direction than the normal insertion section 26A. A connection portion between the run-up portion 26B and the normal insertion section 26A is curved in a circular arc shape. The run-up portion 26B extends in a linear shape upward from an upper end portion (right end portion) of the normal insertion section 26A, and is set with an inclination angle of from 80° to 90° with respect to the left-right direction. Due to the run-up portion 26B being provided, a configuration is achieved such that when the webbing 32 has moved to the right side with respect to the webbing insertion through-hole 26 during a vehicle head-on collision, the webbing 32 then runs up inside the run-up portion 26B (see the webbing 32 illustrated by the double-dot broken line in FIG. 4).

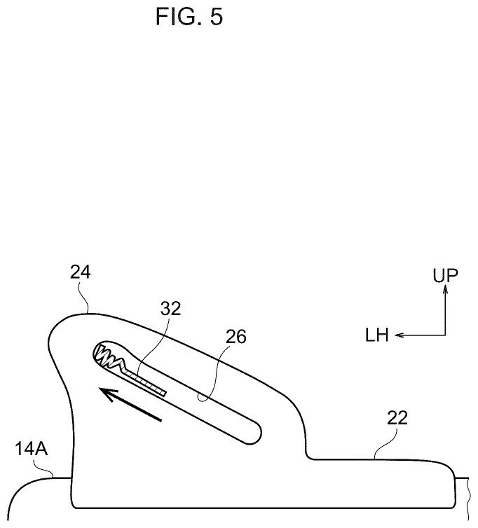

In the present exemplary embodiment, the length of the run-up portion 26B is, as an example, set slightly smaller than the length of the normal insertion section 26A. The length of the run-up portion 26B is set to a length capable of preventing the webbing 32 that has run up as described above from creasing (concertinaing with a zig-zag cross-section) inside the upper end portion of the run-up portion 26B (namely, inside the upper end portion of the webbing insertion through-hole 26). Namely, in a configuration lacking the run-up portion 26B, such as in the comparative example illustrated in FIG. 5, when the webbing 32 has moved toward the right with respect to the webbing insertion through-hole 26 during a vehicle head-on collision, the webbing 32 creases at a right side end portion of the webbing insertion through-hole 26, however, this can be prevented in the present exemplary embodiment.

The belt guide section 24 where the webbing insertion through-hole 26 is formed includes an upper portion of a right edge jutting out further toward the right side (seat width direction outer side) than a lower portion of the right edge. The belt guide section 24 is, as illustrated in FIG. 1, arranged at a position so as not to jut out toward the right side from the shoulder section 14A of the seatback 14.

In the belt guide section 24, a slit 28 is formed in communication with a height direction intermediate portion of the webbing insertion through-hole 26 from the left side (seat width direction inner side). The slit 28 is in communication with a connection portion between the normal insertion section 26A and the run-up portion 26B of the webbing insertion through-hole 26. The slit 28 is formed from a left-side face of the belt guide section 24 to the webbing insertion through-hole 26, and extends in the left-right direction.

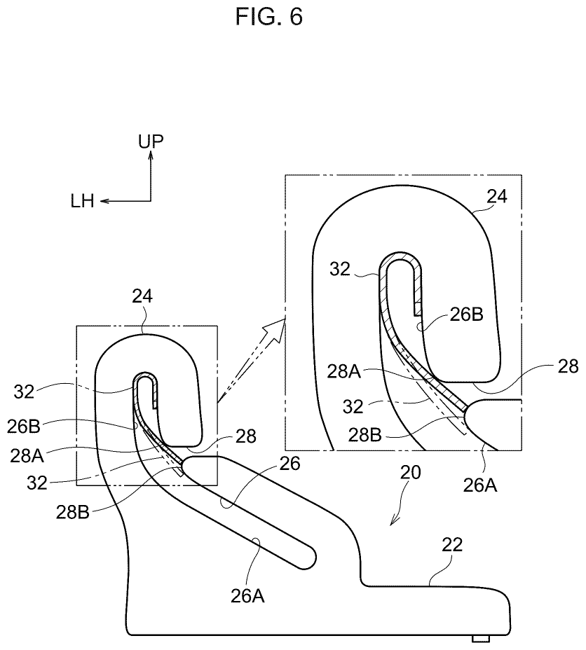

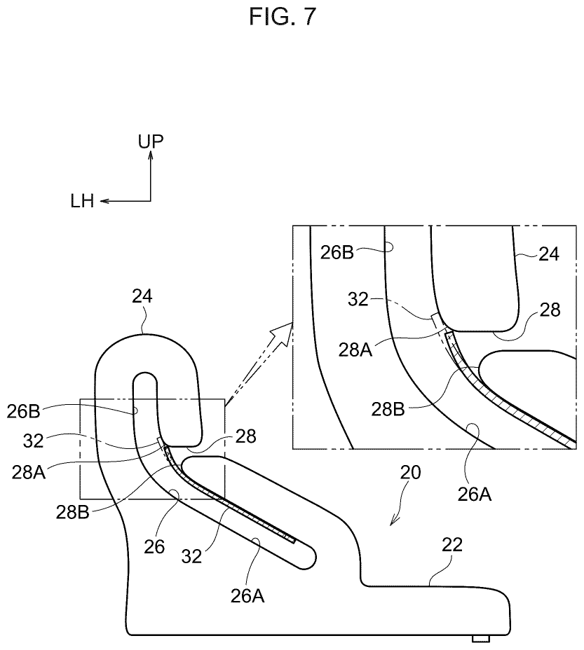

A portion on the left-side face of the belt guide section 24 further to the lower side than the slit 28 is configured as an inclined face having a downward gradient toward the left side, and a portion further to the upper side than the slit 28 is configured as a substantially vertical face. The webbing 32 is able to be inserted through the slit 28 to inside the webbing insertion through-hole 26. As illustrated in FIG. 6 and FIG. 7, an upper edge portion 28A and a lower edge portion 28B of an opening on the webbing insertion through-hole 26 side of the slit 28 are formed with rounded-face profiles.

As illustrated in FIG. 6, configuration is such that, when the webbing 32 moves toward the upper end side of the webbing insertion through-hole 26 and a width direction one-end portion of the webbing 32 contacts the lower edge portion 28B of the opening of the slit 28 (see the webbing 32 illustrated by the solid line in FIG. 6), a width direction one-end portion of the webbing 32 slides along a rounded face of the lower edge portion 28B, such that the width direction one-end portion of the webbing 32 falls to the webbing insertion through-hole 26 side (see the webbing 32 illustrated by the double-dot broken lines in FIG. 6). A configuration that prevents entry of the webbing 32 inside the slit 28 is thereby achieved.

Moreover, as illustrated in FIG. 7, when the webbing 32 moves further toward the upper face side of the webbing insertion through-hole 26 than the slit 28 and the width direction other-end portion of the webbing 32 has contacted the upper edge portion 28A of the opening of the slit 28 (see the webbing 32 illustrated by the solid line in FIG. 7), due to the width direction other-end portion of the webbing 32 sliding against the rounded face of the upper edge portion 28A, a configuration is achieved in which the width direction other-end portion of the webbing 32 displaces toward the webbing insertion through-hole 26 side (see the webbing 32 illustrated by the double-dot broken lines in FIG. 7). A configuration is thereby achieved in which the webbing 32 is prevented from entering inside the slit 28.

In the vehicle seat 10 of the configuration described above, the back of the passenger P seated on the seat cushion 12 is supported by the seatback 14. The base section 22 of the seatbelt guide 20 is fixed to the shoulder section 14A of the seatback 14. In this seatbelt guide 20, the webbing insertion through-hole 26 through which the webbing 32 of the three-point seatbelt device 30 has been inserted is formed to the belt guide section 24 extended upward from the base section 22.

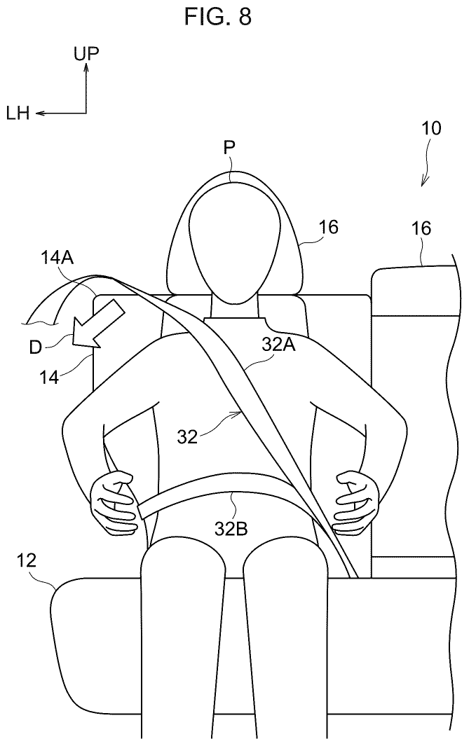

The webbing insertion through-hole 26 is configured in an elongated hole shape inclined upward on progression toward the seat width direction outer side. This accordingly means that the webbing 32 is not liable to move toward the seat width direction outer side and lower side inside the webbing insertion through-hole 26 under load from the passenger P during a vehicle head-on collision. As a result thereof, the shoulder belt 32A of the webbing 32 can be better prevented from slipping from the seat width direction outer side toward the lower side with respect to the shoulder of the passenger P (see arrow D in FIG. 8), as in the comparative example illustrated in FIG. 8. Moreover, in the present exemplary embodiment, due to the above advantageous effects being obtained merely by the shape of the webbing insertion through-hole 26, there is no need for a special adjustment mechanism or the like.

Moreover, in the present exemplary embodiment, the run-up portion 26B, which is the upper portion of the webbing insertion through-hole 26, is set with a larger inclination angle with respect to the seat width direction than the normal insertion section 26A, which is the lower portion of the webbing insertion through-hole 26. This thereby enables the webbing 32 to run up inside the run-up portion 26B even in cases in which the webbing 32 has moved toward the seat width direction outer side (namely, the upper side) inside the webbing insertion through-hole 26 due to load from the passenger P during a vehicle head-on collision. This thereby enables the webbing 32 to be prevented from creasing inside a seat width direction outer side end portion of the webbing insertion through-hole 26, as is the case in the comparative example illustrated in FIG. 5.

Furthermore, in the present exemplary embodiment, the slit 28 is formed at the belt guide section 24 so as to be in communication with the webbing insertion through-hole 26. The webbing 32 can be inserted inside the webbing insertion through-hole 26 from the slit 28. Moreover, the slit 28 is in communication with a height direction intermediate portion of the webbing insertion through-hole 26 from the seat width direction inner side, and so the webbing 32 is easily prevented from coming out from the webbing insertion through-hole 26 unintentionally.

Moreover, in the present exemplary embodiment, the upper edge portion 28A and the lower edge portion 28B of the opening on the webbing insertion through-hole 26 side of the slit 28 are formed with rounded-face profiles. This accordingly means that the width direction end portions of the webbing 32 are not liable to enter inside the slit 28 even when the webbing 32 moves up or down inside the webbing insertion through-hole 26. As a result thereof, the webbing 32 is even more easily prevented from coming out from the webbing insertion through-hole 26 unintentionally.

Moreover, in the present exemplary embodiment, the normal insertion section 26A, which is the lower portion of the webbing insertion through-hole 26, is formed in a linear shape, and so resistance can be reduced when the webbing 32 slides in the front-rear direction inner side the normal insertion section 26A. Moreover, the inclination angle of the normal insertion section 26A is set to not more than 45°, and so good webbing take-up characteristics can be achieved for the retractor of the three-point seatbelt device 30.

Furthermore, in the present exemplary embodiment, the belt guide section 24 of the seatbelt guide 20 is arranged at a position so as not to jut out to the seat width direction outer side from the shoulder section 14A of the seatback 14, enabling the belt guide section 24 to be configured so as not to get in the way when the seatback 14 is being tilted forward or tilted backward.

Moreover, in the present exemplary embodiment, the width dimension of the webbing insertion through-hole 26 is set to 7 mm or less, and so passengers can be prevented from jamming their fingers in the webbing insertion through-hole 26. Moreover, a peripheral portion and both length direction end portions of the webbing insertion through-hole 26 are formed with rounded-face profiles, and so severing of the webbing 32 in the seatbelt guide 20 can be prevented during a vehicle head-on collision.

Note that although in the above exemplary embodiment an upper portion of the webbing insertion through-hole 26 is configured as the run-up portion 26B, there is no limitation thereto, and a configuration may be adopted in which the webbing insertion through-hole 26 lacks the run-up portion 26B (see FIG. 5).

Moreover, although in the above exemplary embodiment a configuration is adopted in which the normal insertion section 26A and the run-up portion 26B of the webbing insertion through-hole 26 are formed with linear shapes, there is no limitation thereto. For example, a webbing insertion through-hole may be configured curved so as to be convex toward the seat width direction outer side and the seat lower side.

In addition thereto, various modifications may be made in the present disclosure within a range not departing from the spirit thereof. Moreover, obviously the scope of rights of the present disclosure is not limited to the above exemplary embodiment.

What is claimed is:

1. A seatbelt guide comprising:
a base section fixed to a shoulder section of a seatback of a vehicle seat; and
a belt guide section that extends from the base section toward a seat upper side and that includes a webbing insertion through-hole, through which a webbing of a three-point seatbelt device is inserted, formed so as to pass through the belt guide section in a seat front-rear direction,
wherein the webbing insertion through-hole is formed in an elongated hole shape inclined toward a seat upper side on progression toward a seat width direction outer side.

2. The seatbelt guide of claim 1, wherein an upper portion of the webbing insertion through-hole is configured as a run-up portion having a greater inclination angle with respect to a seat width direction than a lower portion of the webbing insertion through-hole.

3. The seatbelt guide of claim 1, wherein a slit is formed at the belt guide section so as to be in communication with a height direction intermediate portion of the webbing insertion through-hole from a seat width direction inner side.

4. The seatbelt guide of claim 3, wherein, in the belt guide section, rounded-face profiles are formed at both upper and lower edge portions of an opening on a webbing insertion through-hole side of the slit.

5. The seatbelt guide of claim 2, wherein the lower portion of the webbing insertion through-hole is formed with a linear shape.

6. The seatbelt guide of claim 2, wherein the lower portion of the webbing insertion through-hole is set with an inclination angle of not greater than 45°with respect to the seat width direction.

7. The seatbelt guide of claim 1, wherein the belt guide section is arranged at a position so as not to jut out to the seat width direction outer side from the shoulder section of the seatback.

8. A vehicle seat comprising:
a seat cushion for a passenger of a vehicle to sit on;
a seatback to support a back of the passenger; and
the seatbelt guide of claim 1 in which the base section is fixed to the shoulder section of the seatback.
